(19) United States
(12) Patent Application Publication
(10) Pub. No.: US 2023/0010889 A1
(43) Pub. Date: Jan. 12, 2023

(54) DEVICE FOR PRODUCING HYDROGEN AND/OR AMMONIA AND A METHOD FOR PRODUCING HYDROGEN AND/OR AMMONIA

(71) Applicants: DENSO CORPORATION, Kariya-city (JP); TOKYO INSTITUTE OF TECHNOLOGY, Tokyo (JP)

(72) Inventors: Takanobu KAJINO, Kariya-city (JP); Ichiro YAMANAKA, Tokyo (JP); Shoji IGUCHI, Tokyo (JP); Ayumu OKANO, Tokyo (JP)

(21) Appl. No.: 17/857,640

(22) Filed: Jul. 5, 2022

(30) Foreign Application Priority Data
Jul. 7, 2021 (JP) 2021-112922
Dec. 24, 2021 (JP) 2021-211108

(51) Int. Cl. C25B 1/02; C25B 1/27; C25B 9/30; C25B 11/042

(52) U.S. Cl. CPC C25B 1/02; C25B 1/27; C25B 9/30; C25B 11/042

(57) ABSTRACT

A hydrogen ammonia producing device is configured to produce hydrogen and/or ammonia. The hydrogen ammonia producing device includes an electrochemical cell including an electrode assembly and an electrolyte solution. The electrode assembly has a cathode, a separator and an anode that are sequentially stacked with each other. The anode is in contact with urea. The electrolyte solution is an alkaline aqueous solution. At least one of the anode or the cathode is in contact with the electrolyte solution. The separator is an ion exchange membrane.

### CROSS REFERENCE TO RELATED APPLICATION

This application is based on Japanese Patent Application No. 2021-112922 filed on Jul. 7, 2021 and Japanese Patent Application No. 2021-211108 filed on Dec. 24, 2021, the disclosures of which are incorporated herein by reference in their entirety.

### TECHNICAL FIELD

The present disclosure relates to a device for producing hydrogen and/or ammonia from urea and water, and a method for producing hydrogen and/or ammonia.

### BACKGROUND

A method for electrolytic hydrolysis of urea using a Teflon (registered trademark) membrane or a polypropylene membrane as a separator is proposed. By this method, ammonia can be produced from urea.

### SUMMARY

One aspect of the present disclosure is a producing device of hydrogen and/or ammonia. The producing device includes an electrochemical cell including an electrode assembly and an electrolyte solution. The electrode assembly has a cathode, a separator, and an anode that are sequentially stacked with each other. The anode is in contact with urea. The electrolyte solution is an alkaline aqueous solution and at least one of the anode and the cathode is in contact with the electrolyte solution. The separator is formed of an ion exchange membrane.

Another aspect of the present disclosure is a method for producing hydrogen and/or ammonia. The method includes forming an electrode assembly by sequentially stacking a cathode, a separator formed of an ion exchange membrane, and an anode, bringing the anode of the electrode assembly into contact with urea and bringing at least one of the anode or the cathode into contact with an electrolyte solution formed of an alkaline aqueous solution, and applying a voltage between the cathode and the anode to generate hydrogen and/or ammonia.

### BRIEF DESCRIPTION OF DRAWINGS

FIG. 1 is a schematic view of a hydrogen/ammonia producing device according to a first embodiment, which has a separator formed of a cation exchange membrane and an electrolyte solution in an anode side portion.

FIG. 2 is a schematic view of a hydrogen/ammonia producing device according to the first embodiment, which has a separator formed of an anion exchange membrane and the electrolyte solution in a cathode side portion.

FIG. 3 is a schematic view of a hydrogen/ammonia producing device according to the first embodiment, which has the electrolyte solution in both the anode side portion and the cathode side portion.

FIG. 4 is a schematic diagram of a hydrogen/ammonia producing device in a first experimental example.

FIG. 5 is a graph showing a relationship between materials of the anode and current density when aqueous urea solution electrolysis reaction is performed under the condition of an applied voltage of 2.0 V in the first experimental example.

FIG. 6 is a graph showing a relationship between the materials of the anode, Faradaic efficiency and oxygen production rate at the anode in the first experimental example.

FIG. 7 is a graph showing relationships between elapsed time and current density, and between elapsed time and Faradaic efficiency in the first experimental example.

FIG. 8 is a graph showing a relationship between materials of the anode and current density when aqueous urea solution electrolysis is performed under the condition of the applied voltage of 1.5 V in the first experimental example.

FIG. 9 is a graph showing a relationship between KOH concentration and urea conversion in a second experimental example.

FIG. 10 is a schematic view of a hydrogen/ammonia producing device in a third experimental example.

FIG. 11 is a graph showing changes in impedance over time in the third experimental example.

FIG. 12 is a graph showing current density and ammonia production in a fourth experimental example.

FIG. 13 is a graph showing relationships between elapsed time and current density, and between elapsed time and applied voltage in a fifth experimental example.

FIG. 14 is a graph showing a relationship between the applied voltage and the current density in the fifth experimental example.

FIG. 15 is a schematic diagram of a hydrogen/ammonia producing device in a sixth experimental example.

FIG. 16 is a graph showing a relationship between elapsed time and current density in the sixth experimental example.

FIG. 17 is a graph showing Faradaic efficiency and production rate of hydrogen in the sixth experimental example.

FIG. 18 is a graph showing Faradaic efficiency and production rate of nitrogen in the sixth experimental example.

FIG. 19 is a graph showing Faradaic efficiency and production rate of oxygen in the sixth experimental example.

### DESCRIPTION OF EMBODIMENTS

To begin with, examples of relevant techniques will be described.

Hydrogen is useful as a fuel for fuel cells and as a raw material for e-fuel and the like. Ammonia is a raw material for hydrogen carriers and chemical fertilizers, and is useful for removing harmful substances such as NOx through selective catalytic reduction (i.e., SCR). On the other hand, urea has a high energy density, so that urea can be safely transported and stored. Further, since urea can be easily obtained from factories and domestic wastewater, urea is attracting attention as a raw material for producing hydrogen and ammonia.

For example, a method for electrolytic hydrolysis of urea using a Teflon (registered trademark) membrane or a polypropylene membrane as a separator is proposed. By this method, ammonia can be produced from urea.

In recent years, an efficiency of electricity generation (specifically, energy conversion efficiency) in a system such as solar power generation is improving and the use of renewable energy is expected to expand. Therefore, it is desired to develop a new method and a device for producing ammonia and hydrogen at low energy utilizing electricity (specifically, an electrolytic reaction).

The present disclosure has been made in view of the above issues, and it is an objective of the present disclosure to provide a device and a method for electrochemically producing hydrogen and/or ammonia from urea and water.

One aspect of the present disclosure is a producing device of hydrogen and/or ammonia. The producing device includes an electrochemical cell including an electrode assembly and an electrolyte solution. The electrode assembly has a cathode, a separator, and an anode that are sequentially stacked with each other. The anode is in contact with urea. The electrolyte solution is an alkaline aqueous solution and at least one of the anode and the cathode is in contact with the electrolyte solution. The separator is formed of an ion exchange membrane.

Another aspect of the present disclosure is a method for producing hydrogen and/or ammonia. The method includes forming an electrode assembly by sequentially stacking a cathode, a separator formed of an ion exchange membrane, and an anode, bringing the anode of the electrode assembly into contact with urea and bringing at least one of the anode or the cathode into contact with an electrolyte solution formed of an alkaline aqueous solution, and applying a voltage between the cathode and the anode to generate hydrogen and/or ammonia.

The producing device includes the configuration described above and the separator is formed of an ion exchange membrane. Therefore, reaction factors can be directly sent from the cathode to the anode or from the anode to the cathode through the ion exchange membrane. Specifically, the reaction factors are OH⁻ and H⁺. Hydrogen is produced at the cathode and ammonia is produced at the anode. In this way, hydrogen and/or ammonia can be efficiently produced.

In the above method, the anode of the electrode assembly is brought into contact with urea, and at least one of the anode or the cathode of the electrode assembly is brought into contact with the electrolyte solution formed of an alkaline aqueous solution. Then, a voltage is applied between the cathode and the anode. By applying a voltage, the reaction factors can be sent directly from the cathode to the anode or from the anode to the cathode. As a result, hydrogen is produced at the cathode and ammonia is produced at the anode. In this way, hydrogen and/or ammonia can be efficiently produced.

As described above, according to the above aspects, it is possible to provide a device and a method for producing hydrogen and/or ammonia from urea and water.

### First Embodiment

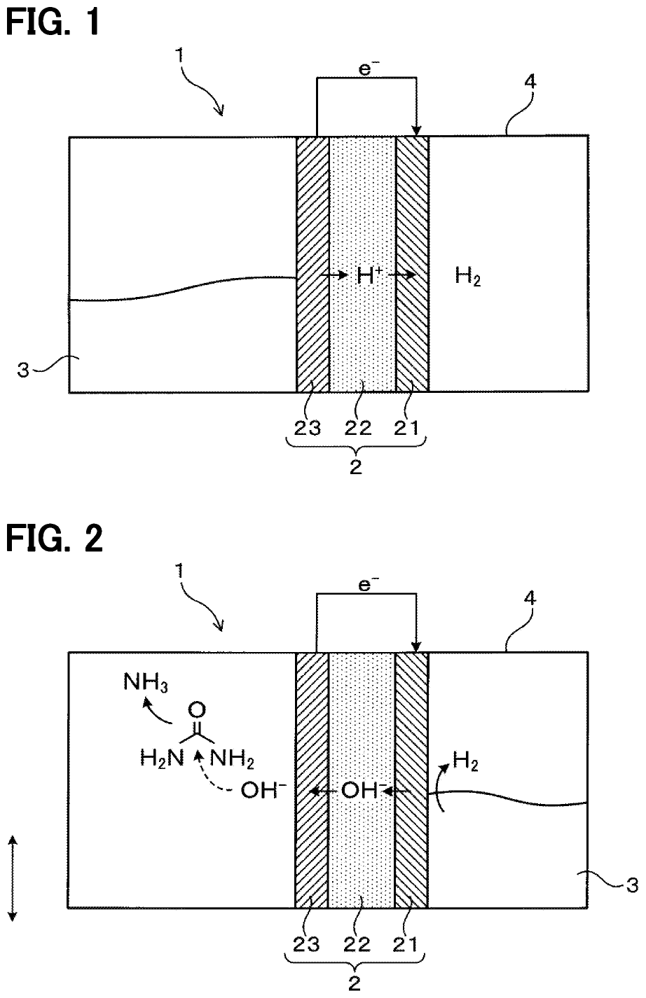

A device and a method for producing hydrogen and/or ammonia in this embodiment will be described with reference to FIGS. 1 to 3. As illustrated in FIGS. 1 to 3, a hydrogen/ammonia producing device 1 is formed of an electrochemical cell 4. The electrochemical cell 4 has an electrode assembly 2 and an electrolyte solution 3.

The electrode assembly 2 has a stacked structure in which a cathode 21, a separator 22, and an anode 23 are sequentially stacked with each other. In the electrode assembly 2, the cathode 21, the separator 22 and the anode 23 are integrally formed with each other. Another layer may be formed between the cathode 21 and the separator 22. Similarly, another layer may be formed between the anode 23 and the separator 22.

In the hydrogen/ammonia producing device 1, the anode 23 is in contact with urea. Further, at least one of the anode 23 and the cathode 21 is in contact with the electrolyte solution 3. That is, only the anode 23 may be in contact with the electrolyte solution 3, only the cathode may be in contact with the electrolyte solution 3, or both of the anode 23 and the cathode 21 may be in contact with the electrolyte solution 3. The electrolyte solution 3 is an alkaline aqueous solution. Further, the separator 22 is formed of an ion exchange membrane, and the ion exchange membrane is a cation exchange membrane or an anion exchange membrane. As described above, there are variations in combinations of the kind of the ion exchange membrane and the electrode in contact with the electrolyte solution in the hydrogen/ammonia producing device 1.

Urea may be supplied as a solid or as an aqueous solution (that is, aqueous urea solution). In the hydrogen/ammonia producing device 1, urea is supplied to the anode 23. When solid urea is supplied, the anode 23 can be in a dry environment (see FIG. 2), so that ammonia produced at the anode 23 can be easily recovered. As shown in FIG. 2, when the anode 23 is in a dry environment, the electrochemical cell 4 is formed by bringing the electrolyte solution 3 into contact with the cathode 21. The contact between the cathode 21 and the electrolyte solution 3 is realized, for example, by immersing the cathode 21 into the electrolyte solution 3. The dry environment means an environment in which a liquid such as the electrolyte solution 3 or aqueous urea solution does not exist, and the dry environment may include water contained in the atmosphere, for example.

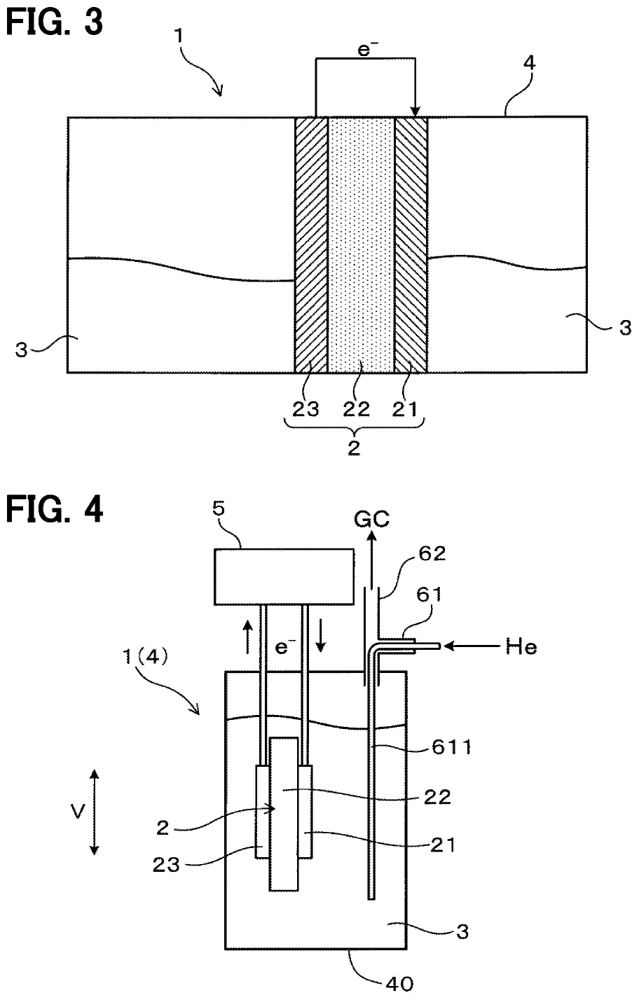

Preferably, the cathode 21 is in contact with the electrolyte solution 3 formed of an alkaline aqueous solution (see FIGS. 2 and 3). In this case, hydrogen is generated from the alkaline aqueous solution.

Further, when the aqueous urea solution is supplied to the anode 23, the electrolyte solution 3 containing urea can be supplied to the anode 23 (see FIGS. 1 and 3). In this case, as shown in FIG. 1, the cathode 21 can be in a dry environment. This allows to easily collect hydrogen generated at the cathode 21. Further, since the generated hydrogen gas becomes babbles in the solution, it can be expected to prevent the generated hydrogen gas from covering the electrode surface and inhibiting the reaction. Further, by introducing an inert gas such as Ar gas from the outside, hydrogen can be easily collected from the dry environment at the cathode 21.

Further, both the anode 23 and the cathode 21 may be brought into contact with the electrolyte solution 3 containing urea (see FIG. 3). That is, both the anode 23 and the cathode 21 may be immersed in the electrolyte solution 3 containing urea.

An alkaline aqueous solution (that is, a basic aqueous solution) is used as the electrolyte solution 3. As the electrolyte solution 3, an aqueous solution of an alkaline metal hydroxide and/or an alkaline earth metal hydroxide can be used. From the viewpoint that the pH can be 14 or more, the alkaline aqueous solution is preferably a KOH aqueous solution. The higher the pH of the alkaline aqueous solution, the more the oxidation of urea is promoted. Thus, the current density can be increased and the hydrogen production rate can be also improved.

When the anode 23 is brought into contact with the electrolyte solution 3, an alkaline aqueous solution containing urea can be used as described above.

The pH of the electrolyte solution 3 at 25° C. is preferably 8 or more. In this case, the oxidation of urea is sufficiently promoted. Thus, the current density is increased and the hydrogen production rate is also improved. From the viewpoint of further improving these effects, the pH of the electrolyte solution 3 at 25° C. is more preferably 12 or more, further preferably 14 or more.

As the anode 23, at least one metal selected from the group consisting of Fe, Co, Ru, Rh, Ni, Ir, Pt, and Cu can be used. Further, as the cathode 21, at least one metal selected from the group consisting of Pt, Ir, Pd, Ru, and Ni can be used. By changing the kind of metal constituting the anode 23, it is possible to generate variations in the products generated through the electrolysis of urea or aqueous urea solution, so that a product other than ammonia can be generated or production of ammonia can be increased. Further, from the viewpoint of increasing the production of ammonia and hydrogen, the anode 23 is preferably an electrode composed of a titanium mesh and a metal deposited on the titanium mesh. The metal is selected from the group described above. Further, from the viewpoint of producing hydrogen easily, the cathode 21 is preferably a complex of a conductive agent formed of a carbon material such as Ketjen black and the metal selected from the group described above.

From the viewpoint of further improving the production of ammonia from the anode 23, it is preferable to use Ru and/or Ni as the anode 23, and it is more preferable to use Ni. Further, from the viewpoint of sufficiently generating hydrogen from the cathode 21, it is preferable to use at least one selected from the group consisting of Rh, Co, and Fe as the anode 23, and more preferable to use Co and/or Fe, and further preferable to use Fe.

The anode 23 preferably contains a base metal. In this case, the anode 23 can be formed without using a precious metal, and the manufacturing cost can be reduced. In the hydrogen/ammonia producing device 1, hydrogen can be generated without using a precious metal for the anode 23. Further, when the anode 23 contains a base metal, the manufacturing cost can be reduced. In this case, the kind and amount of the product can be controlled by selecting the base metal.

The separator 22 is formed of an ion exchange membrane. As the ion exchange membrane, a cation exchange membrane or an anion exchange membrane can be used.

As shown in FIG. 1, in case that the separator 22 is formed of a cation exchange membrane, when a voltage is applied between the anode 23 and the cathode 21, the reaction factor H⁺ flows from the anode 23 to the cathode 21 through the cation exchange membrane. At this time, the reactions of the following equations <2.1>, <2.2>, <2.3>, and <2.4> occur at the anode 23. That is, through co-electrolysis of urea and water, NHx species such as ammonia, NCO species, N₂, CO₂ and the like are formed. The forming reactions are triggered by the forming reaction of hydrogen ions (i.e., protons) from urea and water as shown in the equation <2.1>, and therefore it is important to start the reaction <2.1>. When a cation exchange membrane is used as the ion exchange membrane, hydrogen ions, which are reaction factors, are sent from the anode 23 to the cathode 21 through the cation exchange membrane, so that the trigger reaction proceeds. It is considered that the subsequent ammonia formation reaction and hydrogen formation reaction are proceeding in this way. Further, at the anode 23, oxygen is generated through the reaction of the equation <2.5>, and electrons and protons are generated. The electrons move to the cathode 21 through an external circuit, and the protons move to the cathode 21 through the cation exchange membrane. At the cathode 21, as shown in the equation <2.6>, electrons and protons react with each other to generate hydrogen. In the equations <2.1> to <2.6>, SHE represents a standard hydrogen electrode, and the electrode potential E⁰ represents a converted value at the standard hydrogen electrode.

[Chemical Formula 1]

(NH₂)₂CO+H₂O ⇄N₂+CO₂+6H⁺+6e⁻,E⁰=+0.36V(SHE) <Equation 2.1>

(NH₂)₂CO⇄2HNCO+N₂+6H⁺6e⁻,E⁰=+0.33V(SHE) <Equation 2.2>

(NH₂)₂CO⇄2HNCO+N₂H₄+2H⁺2e⁻,E⁰=+0.22V(SHE) <Equation 2.3>

(NH₂)₂CO⇄2HNCO+NH₃ <Equation 2.4>

2H₂O⇄O₂+4H⁺+4e⁻,E⁰=+1.23V(SHE) <Equation 2.5>

2H⁺+2e⁻⇄H₂,E⁰=0(SHE) <Equation 2.6>

As shown in FIG. 2, in case that the separator 22 is formed of an anion exchange membrane, when a voltage is applied between the anode 23 and the cathode 21, the reaction factor OH⁻ flows from the cathode 21 to the anode 23 through the anion exchange membrane. At this time, the reactions of the following equations <3.1>, <3.2>, and <3.3> occur at the anode 23. The reaction shown in <3.3> further causes the reactions shown in <3.3.1> to <3.3.4>. That is, at the anode 23, nitrogen, carbon dioxide and the like are formed through the reaction between OH⁻ and urea, and ammonia is generated from urea. The formation reactions are triggered by the reaction between urea and hydroxide ions as shown in the equation <3.1>. Thus, it is important to start the reaction of the equation <3.1>. When an anion exchange membrane is used as the ion exchange membrane, hydroxide ions, which are reaction factors, are sent from the cathode 21 to the anode 23 through the anion exchange membrane, so that the trigger reaction proceeds. It is considered that the subsequent ammonia production reaction and hydrogen production reaction proceed in this way. Further, electrons are generated at the anode 23. The electrons move to the cathode 21 through the external circuit. Then, at the cathode 21, water reacts with electrons to generate hydrogen, as shown in the equation <3.4>. In the equations <3.1> to <3.4>, SHE represents a standard hydrogen electrode, and the electrode potential E⁰ represents a converted value at the standard hydrogen electrode.

[Chemical Formula 2]

(NH₂)₂CO+6OH⁻→N₂+CO₂+5H₂O+6e⁻,E⁰=−0.459V(SHE) <Equation 3.1>

4OH⁻→O₂+2H₂O+4e⁻,E⁰=0.402V(SHE) <Equation 3.2>

(NH₂)₂CO⇄2HNCO+NH₃ <Equation 3.3>

2NH₃+6OH⁻→N₂+6H₂O+6e⁻,E⁰=−0.781V(SHE) <Equation 3.3.1>

NH₃+5OH⁻→NO+4H₂O+5e⁻,E⁰=−0.101V(SHE) <Equation 3.3.2>

NH₃+7OH⁻→NO₂+5H₂O+7e⁻,E⁰=−0.01V(SHE) <Equation 3.3.3>

HNCO+2OH⁻→NH₃+CO₂+½O₂+2e⁻,E⁰=0.343V(SHE) <Equation 3.3.4>

2H₂O+2e⁻→H₂+2OH⁻,E⁰=−0.827V(SHE) <Equation 3.4>

As shown in the above reaction equations, in the hydrogen/ammonia producing device 1, hydrogen is generated at the cathode 21 and ammonia is generated at the anode 23. It is preferable that the electrode assembly 2 compartmentalizes the anode 23 and the cathode 21. In this case, it is possible to prevent hydrogen generated at the cathode 21 from being mixed with ammonia generated at the anode 23. Therefore, it is easy to collect hydrogen and ammonia separately.

Specifically, the hydrogen/ammonia producing device 1 defines a cathode reaction chamber to face the cathode 21 of the electrode assembly 2 and an anode reaction chamber to face the anode 23. The anode reaction chamber is separated from the anode reaction chamber by the electrode assembly 2. As a result, hydrogen generated in the cathode reaction chamber and ammonia generated in the anode reaction chamber can be collected separately.

The ion exchange membrane is preferably an anion exchange membrane. When the ion exchange membrane is a cation exchange membrane, ammonium ions generated through the electrolytic reaction of aqueous urea solution are ion-exchanged in the cation exchange membrane, thereby increasing the electrical resistance of the cation exchange membrane. As a result, the cation exchange membrane is damaged and loses its function over time. Therefore, it becomes impossible to sufficiently generate ammonia and hydrogen. In contrast, when the ion exchange membrane is an anion exchange membrane, ammonium ions are not ion-exchanged and the electric resistance does not increase in the anion exchange membrane. Therefore, ammonia and hydrogen can be continuously produced, which increases the production of ammonia and hydrogen.

The anion exchange membrane is preferably formed of a polymer containing at least one ligand selected from the group consisting of an imidazolium ligand, a pyridinium ligand, and a phosphonium ligand. More specifically, it is preferable that the anion exchange membrane is formed of a polymer having a ligand portion and a skeleton portion chemically bonded to the ligand portion and that the ligand portion is formed of at least one functional group selected from the group consisting of an imidazolium group, a pyridinium group and a phosphonium group, or a salt thereof. From the viewpoint of stability of the functional group and base strength, the ligand is preferably an imidazolium ligand. In other words, the ligand portion is preferably formed of an imidazolium group or a salt of the imidazolium group. The skeleton portion is formed of, for example, a styrene-based resin such as polystyrene or styrene divinylbenzene copolymer; an acrylic resin such as polyhydroxymethacrylate; or polyvinyl alcohol.

In the hydrogen/ammonia producing device 1 of this embodiment, the separator 22 is formed of an ion exchange membrane. Therefore, the reaction factor can be directly sent from the cathode 21 to the anode 23 or from the anode 23 to the cathode 21 through the ion exchange membrane. This makes it possible to control the local pH at the reaction point of the electrode. Specifically, the reaction of the above equation <2.1> triggers an increase in the local proton concentration at the cathode 21 and the equation <3.1> triggers an increase in the local OH⁻ concentration at the anode 23. Therefore, it is possible to cause a reaction that does not depend on the pH of the electrolyte solution. More specifically, for example, when an anion exchange membrane is used as the ion exchange membrane, OH⁻ is generated at the anode 23, so that an environment in which the pH is locally increased is formed on the surface of the anode 23. Therefore, even when the pH of the electrolyte solution is near neutral (for example, the pH falls within 8 to 12), the reactions of forming ammonia and hydrogen proceed, and hydrogen and ammonia can be formed.

As described above, according to the hydrogen/ammonia producing device 1 of the present embodiment, hydrogen is generated at the cathode 21 and ammonia is generated at the anode 23. In this way, at least one or both of hydrogen and ammonia can be efficiently produced.

Next, a method for producing hydrogen and/or ammonia will be described. Although this method is easily realized by the above-mentioned producing device, the method of the present disclosure is not limited to the method using the above-mentioned producing device. The method for producing hydrogen and/or ammonia includes an electrode forming step, an assembly step, and a voltage applying step.

In the electrode forming step, the cathode 21, the separator 22, and the anode 23 are sequentially stacked with each other. As a result, an electrode assembly 2 having a stacked structure of the cathode 21, the separator 22, and the anode 23 is formed. The cathode 21, the separator 22, and the anode 23 are as described above.

In the assembly step, the anode 23 of the electrode assembly 2 is brought into contact with urea, and at least one of the anode 23 and the cathode 21 is brought into contact with the electrolyte solution 3 formed of an alkaline aqueous solution. As a result, the electrode assembly 2 and the electrolyte solution 3 form the electrochemical cell 4. The urea and the electrolyte solution 3 are as described above.

In the voltage applying step, a voltage is applied between the cathode 21 and the anode 23. As a result, hydrogen is generated at the cathode 21 and ammonia is generated at the anode 23.

In the production method of this embodiment, the anode 23 of the electrode assembly 2 is brought into contact with urea, and at least one of the anode 23 and the cathode 21 of the electrode assembly 2 is brought into contact with the electrolyte solution 3 formed of an alkaline aqueous solution. Then, a voltage is applied between the cathode 21 and the anode 23. By applying a voltage, the reaction factor can be sent directly from the cathode 21 to the anode 23 or from the anode 23 to the cathode 21. This makes it possible to control the local pH at the reaction point of the electrode. In this way, the same or similar advantages as those of the above-mentioned producing device can be obtained. Then, hydrogen is generated at the cathode 21 and ammonia is generated at the anode 23. In this way, at least one or both of hydrogen and ammonia can be efficiently produced.

### First Experimental Example

In this example, hydrogen and ammonia are formed by the hydrogen/ammonia producing device 1 having an anion exchange membrane. In this example, material of the anode 23 in the hydrogen/ammonia producing device 1 is variously changed and influence of the material change is investigated. Among reference numerals used in the first experimental example and subsequent examples, the same reference numerals as those used in the above-described embodiment represent the same constituent elements and the like as those in the above-described embodiment unless otherwise indicated.

In this example, the hydrogen/ammonia producing device 1 was constructed as shown in FIG. 4. Specifically, at first, AdBlue (a registered trademark of the German Association of the Automotive Industry (i.e., VDA) SBIB), which is an aqueous urea solution manufactured by Mitsui Chemicals, was prepared. The urea concentration of this aqueous urea solution is 32.5 wt %. KOH equivalent to 1M was dissolved in this aqueous urea solution to prepare an alkaline aqueous solution containing urea (that is, the electrolyte solution 3) is prepared. The pH of the alkaline aqueous solution is 14 or more. Next, 30 mL of the electrolyte solution 3 was placed in a one-chamber type container 40, and the electrode assembly 2 in which the anode 23, the separator 22 and the cathode 21 were integrally formed with each other was immersed in the electrolyte solution 3.

As the cathode 21, an electrode formed of a mixture of Ketjen black and Pt was used. As the anode 23, an electrode in which Fe, Co, Ru, Rh, or Ni was deposited on a titanium mesh was used. That is, Fe/Ti catalyst, Co/Ti catalyst, Ru/Ti catalyst, Rh/Ti catalyst, and Ni/Ti catalyst were respectively used as the anode 23. As the separator 22, Sustainion (registered trademark) X-37, which is an anion exchange membrane manufactured by Dioxide Materials, was used.

In the hydrogen/ammonia producing device 1 of this example, the electrochemical cell 4 is formed of the electrode assembly 2 and the electrolyte solution 3 in which the electrode assembly 2 is immersed.

The cathode 21 and the anode 23 are electrically connected to an electrochemical measuring device 5 (specifically, a potentiostat/galvanostat). Specifically, the anode 23 is connected to the electrochemical measuring device 5 as a sample electrode (the sample electrode is also called a working electrode), and the cathode 21 is connected to the electrochemical measuring device 5 as a counter electrode.

As shown in FIG. 4, a tube 611 made of polytetrafluoroethylene (i.e., PTFE) is inserted into the electrolyte solution 3 in the container 40, and this tube is fluidly connected to a gas inlet 61 defined at an upper portion of the container 40 in a vertical direction. Further, a gas outlet 62 is defined at an upper portion of the container 40 and the gas outlet 62 is fluidly connected to a sample measurement unit of a gas chromatography. “GC” in FIG. 4 represents gas chromatography.

Next, helium gas (i.e., He) was blown into the container 40 through the gas inlet 61 while stirring the electrolyte solution 3 using a magnetic stirrer, and air in the container 40 was replaced with He. The flow condition of He is 0.1 MPa and 20 m L/min.

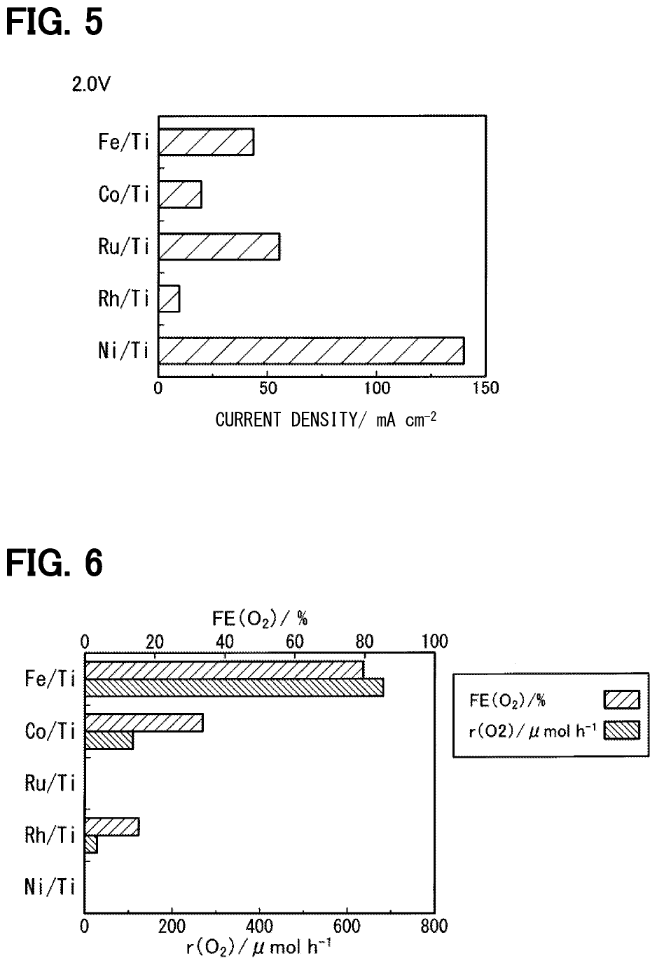

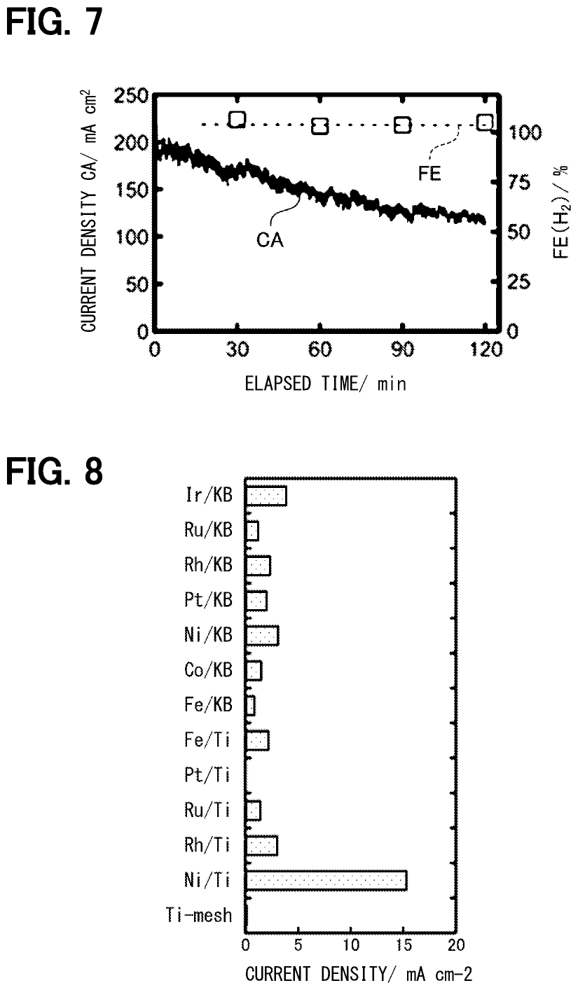

While continuously performing gas replacement with He for 60 minutes or more, an open circuit voltage was measured. Next, the voltage applied between the anode 23 and the cathode 21 was controlled to 2.0 V, and constant voltage electrolysis was performed for 2 hours. Then, the aqueous urea solution electrolysis activity was evaluated. The evaluation was performed by measuring average current density, Faradaic efficiency of oxygen (that is, FE (O₂)), and the rate of oxygen production (that is, r(O₂)). The results are shown in FIGS. 5 to 7. Note that FIG. 7 shows changes in current density and Faradaic efficiency of hydrogen over time when an electrode in which Ni is deposited on a titanium mesh is used as the anode 23.

In the hydrogen/ammonia producing device 1 of this example, it is considered that the reactions of the above formulas <3.1> to <3.4> occur. That is, in the anode 23, N₂ and CO₂ are generated through co-electrolysis of urea and water according to the formula <3.1>. Further, the O₂ producing reaction proceeds through water electrolysis according to the formula <3.2>. Then, the electrons generated at the anode 23 move to the cathode 21 through an external circuit of the electrochemical cell 4, and water and the electrons react at the cathode 21 according to the formula <3.4>, so that the H₂ forming reaction proceeds. Electrolysis was carried out at a constant voltage as described above. For example, when Pt/KB is used as the cathode 21, it is generally known that high activity is exhibited in the H₂ forming reaction and an overvoltage is small even in a high current density region. Therefore, in this example, the experiment was conducted by regarding the voltage between both electrodes as the anode potential.

In this example, as described above, the electrode catalytic activity was evaluated based on the average current density, the production rate of products such as O₂, and the selectivity of the products (specifically, Faradaic efficiency). The Faradaic efficiency FE was calculated based on equation (I) by assuming that all of the N₂ forming reaction proceeds based on the formula <3.1> that is a 6-electron reaction. In the equation (I), Y indicates a product yield (unit: mol), n indicates the number of reaction electrons (unit: −), and Q indicates the amount of electric charge (unit: C).

FE (%)=100×Y×n×F/Q (I)

If the electrolytic reaction of the aqueous urea solution as shown in the above formula <3.1> proceeds, the same amount of N₂ and CO₂ equivalent to urea (that is, (NH₂)₂CO) should be generated. However, since a strong basic solution is used as the electrolyte solution 3 in this example, CO₂ is dissolved in the aqueous solution (i.e., the electrolyte solution 3). Therefore, the CO₂ detected by gas chromatography is a part of the CO₂ produced through the reaction. Therefore, the selectivity of the N₂ forming reaction was regarded as the selectivity of the aqueous urea solution electrolysis reaction, and the catalytic activity was evaluated by comparing with the selectivity of the O₂ forming reaction through water electrolysis. That is, as shown in FIG. 6, by examining the O₂ forming rate and the selectivity of the O₂ forming reaction, it is possible to evaluate the hydrogen forming rate, the ammonia forming rate, the hydrogen selectivity, and the ammonia selectivity.

As can be understood from FIGS. 5 and 6, when the Fe/Ti catalyst was used for the anode 23, the current density was close to 50 mA cm⁻². Further, in this case, since the Faradaic efficiency of O₂ exceeds 80% and the forming rate of O₂ is close to 700 μmol h⁻¹, hydrogen can be mainly formed through electrolysis. On the other hand, the production of ammonia can be suppressed. That is, when Fe/Ti catalyst is used, hydrogen can be preferentially generated. Co/Ti catalyst and Rh/Ti catalyst are similar to this.

As can be understood from FIGS. 5 and 6, when Ni/Ti catalyst was used for the anode 23, the current density was close to 150 mA cm⁻². On the other hand, the Faradaic efficiency of O₂ is 0, and O₂ is not generated. Ammonia formation can be promoted along with hydrogen formation through electrolysis. The Ru/Ti catalyst is similar to this.

As can be understood from FIG. 7, when Ni/Ti catalyst was used for the anode 23, a high current density exceeding 100 mA cm⁻² was exhibited even after 2 hours. Further, hydrogen was formed at the cathode 21 at a production rate of 5 mmol h⁻¹, with a current efficiency of 100%, and highly efficient hydrogen production proceeded through aqueous urea solution electrolysis.

Further, by gas chromatograph analysis, the formation of N₂ and a small amount of CO₂ were observed in the gas phase at the anode 23. It is considered that most of the produced CO₂ was dissolved in the alkaline aqueous solution (that is, the electrolytic solution 3) as described above. Moreover, when the outlet gas was analyzed by gas chromatograph analysis, almost no harmful compounds such as NO₂ and NO were observed.

Further, the same experiment was performed except that Ir/KB, Ru/KB, Rh/KB, Pt/KB, Ni/KB, Co/KB, Fe/KB, Fe/Ti, Pt/Ti, Ru/Ti, Rh/Ti, Ni/Ti or Ti-mesh was used as the anode 23 and that the voltage applied between the anode 23 and the cathode 21 was set to 1.5 V to electrolyze the aqueous urea solution, and the measurement results of the average current density are shown in FIG. 8. Ir/KB represents an electrode in which iridium is deposited on Ketjen black, and Fe/Ti means an electrode in which iron is deposited on a titanium mesh. The same applies to other electrodes.

As can be seen from FIG. 8, among various transition metals and precious metals used for the anode 23, Ni/Ti catalyst showed extremely high activity in the electrolytic reforming reaction of aqueous urea solution. Therefore, in order to generate ammonia and hydrogen from urea, it is preferable to use Ni/Ti electrode for the anode 23.

### Second Experimental Example

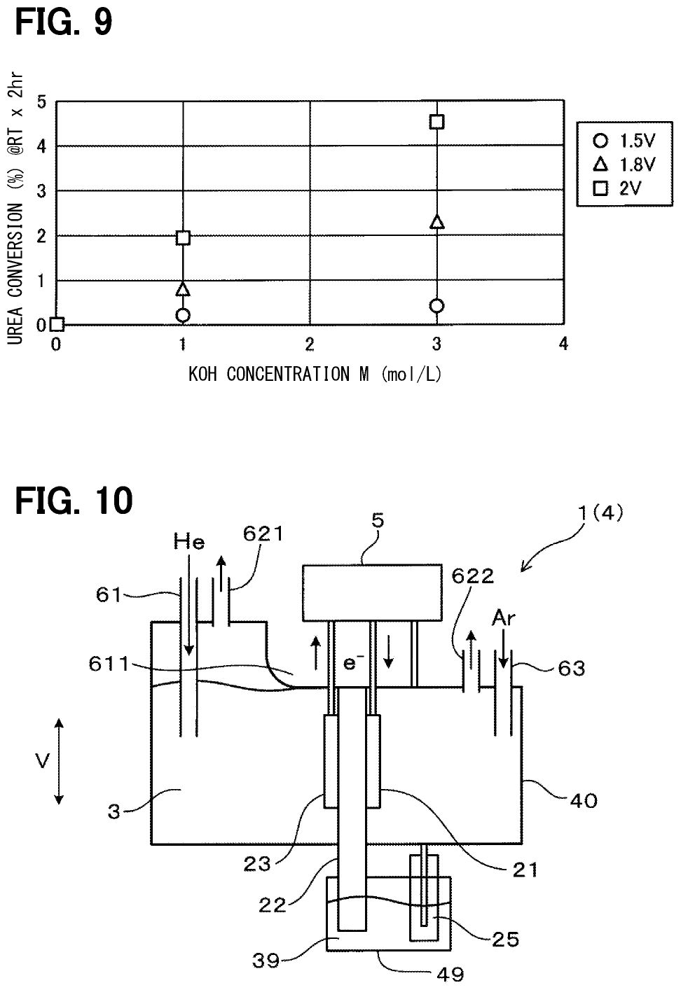

In this example, the influence of the KOH concentration in the electrolyte solution on the urea conversion rate was investigated. At first, the hydrogen/ammonia producing device 1 same as in the first experimental example was produced. Ni/Ti was used as the anode 23. The urea conversion rate was measured and calculated under the condition that the KOH concentration in the electrolyte solution was 0.1M or 3M at room temperature (25° C.) and a voltage of 1.5V, 1.8V or 2V was applied between the cathode and the anode for 2 hours. The results are shown in FIG. 9.

The urea conversion rate was calculated based on the following equation (II).

Urea conversion rate=amount of substance of urea used in the reaction/total amount of substance of urea (II)

The total amount of substance of urea is calculated from the urea concentration of the aqueous urea solution (32.5 wt % in this example).

“The amount of substance of urea used in the reaction” is calculated based on the following equation (III) with the energization amount and the Faradaic efficiency of O₂ (that is, FE).

Amount of substance of used urea=energization amount/96485×(1−FE of O₂)/6

This urea conversion rate is an apparent conversion calculated by assuming that all of the remainder of electricity, which is obtained by subtracting the amount of electricity used for oxygen formation from the total energization amount, is used for the electrolysis of urea, that is, the 6-electron reaction in the above formula <3.1> proceeds.

As can be understood from FIG. 9, in the hydrogen/ammonia producing device 1 of this example, it can be seen that the aqueous urea solution electrolysis reaction sufficiently proceeds even with the electrolyte solution having a low KOH concentration (e.g., 1M). That is, even in a low-concentration KOH aqueous solution, ammonia is generated at the anode 23 and hydrogen is generated at the cathode 21 through the aqueous urea solution electrolysis reaction. It is considered that this is because by using the anion exchange membrane as the separator 22, the pH is locally increased and the aqueous urea solution electrolysis reaction is promoted even in a low KOH concentration environment.

### Third Experimental Example

In this example, hydrogen and ammonia are formed with the hydrogen/ammonia producing device 1 having a cation exchange membrane. In this example, the hydrogen/ammonia producing device 1 shown in FIG. 10 was constructed.

First, an alkaline aqueous solution containing urea (that is, electrolyte solution 3) was prepared in the same manner as in the first experimental example. Next, an electrode assembly 2 in which the anode 23, the separator 22 and the cathode 21 are integrally formed with each other is produced, and the electrode assembly 2 is inserted into the container 40 (specifically, a first container 40) to separate an inner space of the container 40 into two spaces. More specifically, the inner space of the container 40 is divided by the separator 22 of the electrode assembly 2. The anode 23 is made of Pt-Black, and the cathode 21 is made of Pt. Pt-Black is a black powder of platinum. As the separator 22, Nafion (registered trademark) 117, which is a cation exchange membrane manufactured by The Chemours Company, was used.

The electrolyte solution 3 (specifically, the first electrolyte solution 3) was injected into the space of the container 40 facing the anode 23. In contrast, the cathode 21 in the container 40 is exposed to a dry environment. A tube 611 made of polytetrafluoroethylene (that is, PTFE) is inserted into the electrolyte solution 3, and the tube 611 is fluidly connected to a gas inlet 61 (specifically, a first gas inlet 61) defined in the upper part of the container 40 in the vertical direction.

Further, a first gas outlet 621 is defined in the upper part of the container 40 on the anode 23 side portion, and the first gas outlet 621 is fluidly connected to the sample measurement unit of gas chromatography. In contrast, a second gas inlet 63 is defined in the cathode 21 side portion of the container 40. In the hydrogen/ammonia producing device 1 of this example, Ar gas is introduced through the second gas inlet 63 in order to send out hydrogen generated at the cathode 21.

Further, a second gas outlet 622 is defined in the upper part of the cathode 21 side portion of the container 40, and the second gas outlet 622 is fluidly connected to the sample measurement unit of gas chromatography. In FIG. 10, the illustration of gas chromatography is omitted.

As shown in FIG. 10, the separator 22 extends beyond the lower portion of the container 40 in the vertical direction V to the outside of the container 40, and a part of the separator 22 is immersed in a second electrolyte solution 39 in a second container 49 that is disposed outside of the container 40. The second electrolyte solution 39 is a 1N H₂SO₄ aqueous solution. Further, an Ag/AgCl electrode 25 as a reference electrode is inserted in this H₂SO₄ aqueous solution.

The cathode 21, the anode 23 and Ag/AgCl electrode 25 are electrically connected to the electrochemical measuring device 5 (that is, the potentiostat/galvanostat). Specifically, the anode 23 is connected to the electrochemical measuring device 5 as a sample electrode (the sample electrode is also called a working electrode), and the cathode 21 is connected to the electrochemical measuring device 5 as a counter electrode, and Ag/AgCl electrode 25 is connected to the electrochemical measuring device 5 as a reference electrode. In the hydrogen/ammonia producing device 1 of this example, a three-pole electrochemical cell 4 is constructed.

Next, helium gas (He) was blown into the container 40 through the first gas inlet 61 while stirring the electrolyte solution 3 using a magnetic stirrer, so that the air in the container 40 was replaced with He. The flow conditions of He were the same as those in the first experimental example.

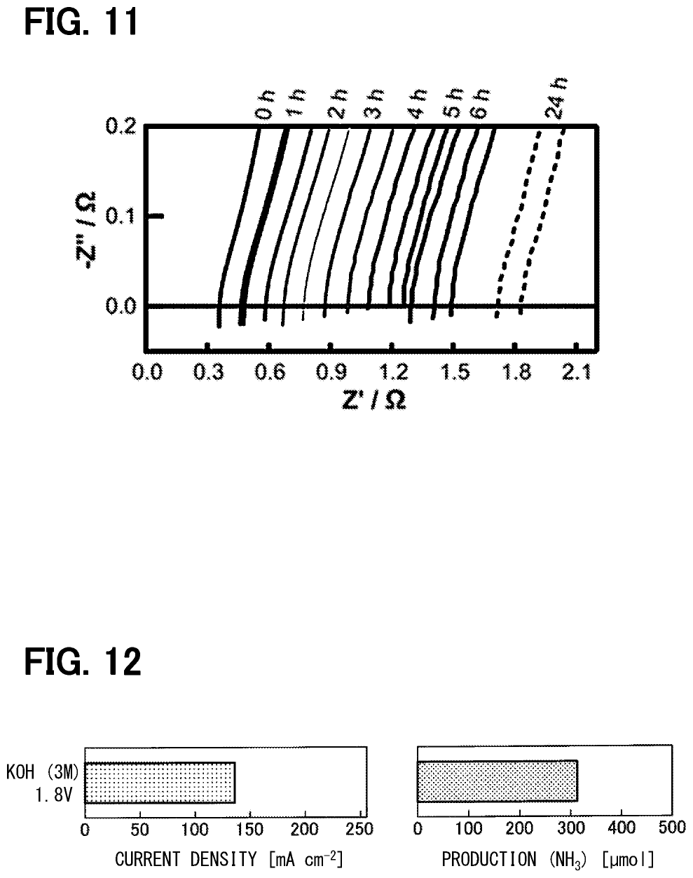

While continuously performing gas replacement with He for 60 minutes or more, an open circuit voltage was measured. Next, the applied voltage between the anode 23 and the cathode 21 was controlled to 1.4 V, and constant voltage electrolysis was performed for 2 hours to allow the aqueous urea solution electrolysis reaction to proceed. At this time, the impedance was measured by the electrochemical measuring device 5. The change in the impedance over time is shown in FIG. 11.

In this example, it was confirmed that HNCO was generated at the anode 23 through the aqueous urea solution electrolysis at room temperature by SPE electrolysis method. Further, according to the formula <3.3>, it can be said that ammonia was generated at the anode 23 through the aqueous urea solution electrolysis reaction. Further, according to the formula <2.5>, it can be said that hydrogen was generated at the cathode 21 through the aqueous urea solution electrolysis reaction.

Further, as can be understood from FIG. 11, in this example, the electrical resistance increases over time.

It is considered that this is because NH₄⁺ in the aqueous urea solution was trapped in the cation exchange membrane by ion exchange. That is, if a cation exchange membrane is used for the separator 22, the membrane may deteriorate over time. Therefore, as the separator 22, an anion exchange membrane is preferable.

### Fourth Experimental Example

In this example, the concentration of ammonia produced from the hydrogen/ammonia producing device 1 is directly detected. First, the hydrogen/ammonia producing device 1 similar to that in the first experimental example 1 was constructed using an electrode in which Ni was deposited on a titanium mesh as the anode 23 (see FIG. 4).

Aqueous urea solution electrolysis was carried out by performing constant voltage electrolysis for 2 hours using this hydrogen/ammonia producing device 1. The method and conditions of aqueous urea solution electrolysis are the same as those of the first experimental example except that the applied voltage between the electrodes is 1.8 V and the KOH concentration of the electrolyte solution is 3 M.

After 2 hours of the constant voltage electrolysis, 30 mL of the electrolyte solution was sampled as a measurement sample, and the ammonia concentration in the measurement sample was measured using an ammonia electrode “Ti9001” manufactured by Toko Kagaku Co., Ltd. The concentration was measured using a calibration curve with an ammonia standard solution. The result of the average current density and the result of the ammonia concentration in this example are shown in FIG. 12.

As can be understood from FIG. 12, in this example, the current density was high, aqueous urea solution electrolysis proceeded efficiently, and ammonia was sufficiently produced. Therefore, it can be seen that ammonia is produced with high efficiency.

Thus, in this example, the production of ammonia was confirmed by the ammonia electrode.

### Fifth Experimental Example

In this example, the dependence of the aqueous urea solution electrolysis reaction on the applied voltage is evaluated. At first, the hydrogen/ammonia producing device 1 similar to that in the first experimental example was constructed using an electrode in which Ni was deposited on a titanium mesh as the anode 23 (see FIG. 4).

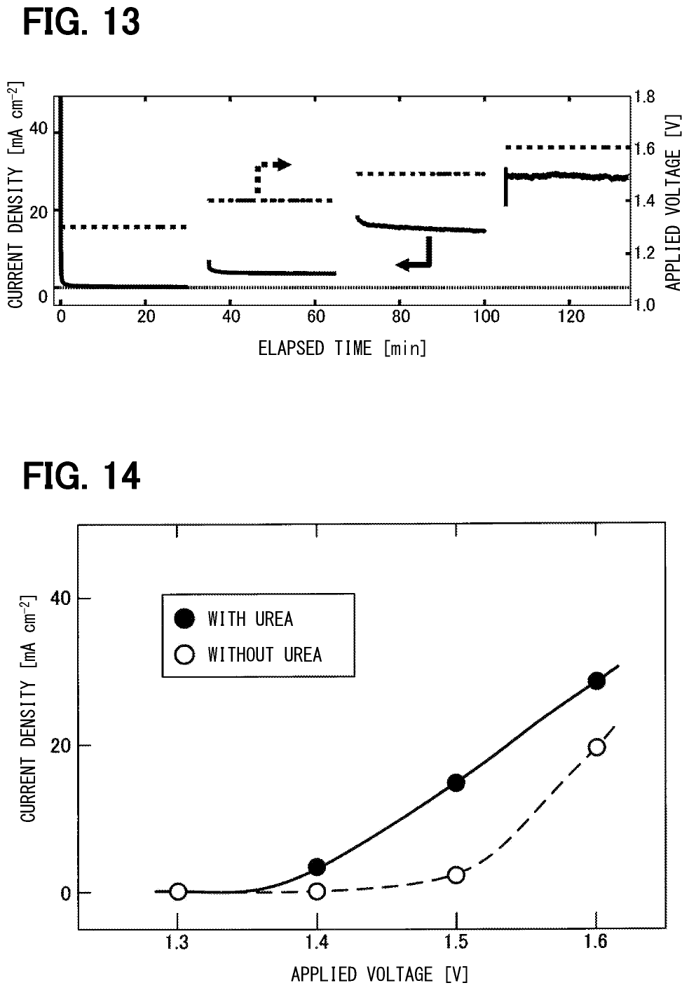

Using this hydrogen/ammonia producing device 1, aqueous urea solution electrolysis was carried out in the same manner as in the first experimental example. The method and conditions for aqueous urea solution electrolysis are the same as those in the first experimental example except that the applied voltage between the electrodes is changed. Specifically, in this example, the voltage was increased from 1.3 V to 1.6 V by 0.1 V every 30 minutes. That is, after performing aqueous urea solution electrolysis at 1.3 V for 30 minutes, the voltage was increased by 0.1 V every 30 minutes to 1.6 V and aqueous urea solution electrolysis was performed at each voltage for 30 minutes. FIG. 13 shows the relationship between the elapsed time, the current density, and the applied voltage in this experiment. As shown in FIG. 13, a voltage non-application time of 5 minutes is provided between the aqueous urea solution electrolysis reactions at different voltages. The relationship between the applied voltage and the current density in this example is shown in FIG. 14 as a solid line.

Further, for comparison with the above-mentioned aqueous urea solution electrolysis, a similar experiment (specifically, water electrolysis) was performed using an electrolyte solution that does not contain urea. The result (that is, the relationship between the applied voltage and the current density) is shown as a broken line in FIG. 14.

As is known from FIG. 14, in the electrolyte solution to which urea is added, the current density becomes high at a lower potential than in the electrolyte solution to which urea is not added, and electrolysis occurs. That is, since aqueous urea solution electrolysis occurs at a lower potential, ammonia and hydrogen can be generated with low energy using aqueous urea solution as a raw material.

### Sixth Experimental Example

In this example, hydrogen and ammonia are generated by a hydrogen/ammonia producing device 1 in which an anion exchange membrane is used as the separator 22 and one of the electrodes is exposed to a dry environment. The productions of hydrogen and ammonia were evaluated by evaluating the decomposition activity of urea.

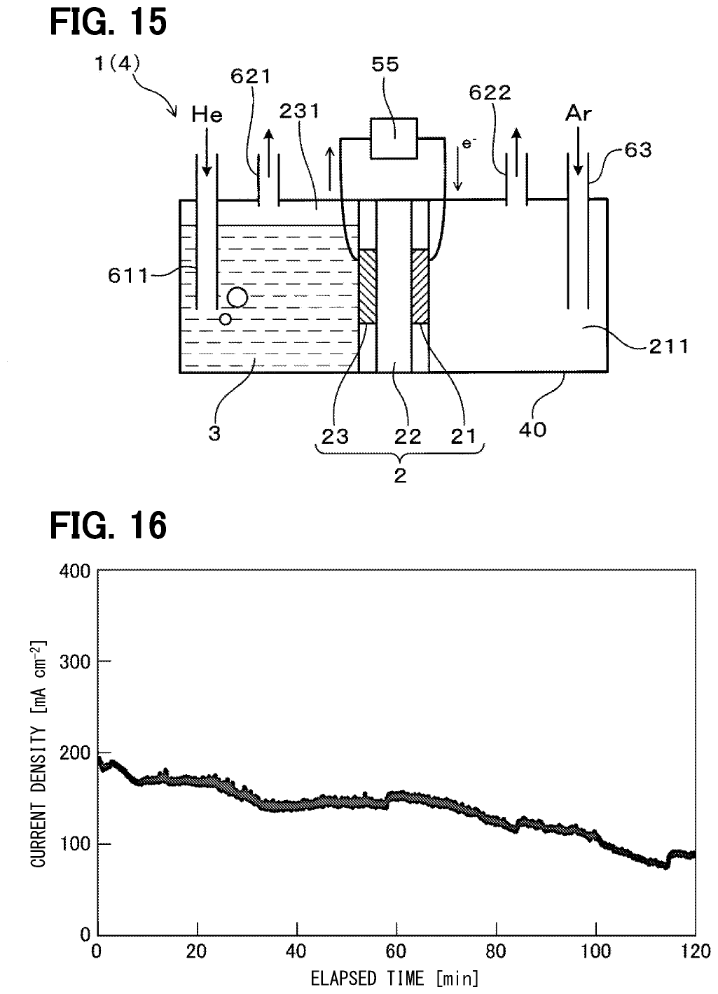

In this example, the hydrogen/ammonia producing device 1 shown in FIG. 15 was constructed. Specifically, at first, an alkaline aqueous solution containing urea (that is, the electrolyte solution 3) was prepared in the same manner as in the first experimental example. Further, the electrode assembly 2 in which the anode 23, the separator 22 and the cathode 21 are integrally formed with each other is inserted into the container 40 whose outer wall is made of PTFE to divide the inner space of the container 40 into two spaces. That is, the inner space of the container 40 was divided by the separator 22 of the electrode assembly 2. As the separator 22, the anion exchange membrane same as in the first experimental example was used. Further, the anode 23 is made of Ni/Ti, and the cathode 21 is made of Pt/KB. The anode 23 and the cathode 21 are each electrically connected to the power supply 55.

As shown in FIG. 15, the electrolyte solution 3 is injected into the space facing the anode 23 in the container 40, and the cathode 21 in the container 40 is exposed to a dry environment. As the electrolyte solution 3, the same one as in the first experimental example was used. In the following descriptions, the space of the container 40 facing the anode 23 and filled with the electrolyte solution 3 is referred to as an anode chamber 231 (i.e., a left chamber in FIG. 15) and the space of the container 40 facing the cathode 21 and exposed to the dry environment is referred to as a cathode chamber 211 (i.e., a right chamber in FIG. 15).

A tube 611 was inserted into the anode chamber 231, and He was flowed into the electrolyte solution 3 through the tube 611. Further, the anode chamber 231 defines a first gas outlet 621. To the first gas outlet 621, a multi-way valve (specifically six-way valve) connected to the gas chromatography and a membrane flow meter are sequentially connected although illustrations of the multi-way valve and the membrane flow meter are omitted. In contrast, the cathode chamber 211 defines a second gas inlet 63 and a second gas outlet 622, and an inert gas (specifically Ar) is circulated in the cathode chamber 211 through the second gas inlet 63 and the second gas outlet 622.

The anode 23 is electrically connected to the operating pole terminal and the potential measuring terminal of the electrochemical measuring device (specifically, the potentiostat/galvanostat) through a gold wire, and the cathode 21 is electrically connected to the outer terminal and the reference electrode terminal of the electrochemical measuring device through a gold wire. In FIG. 15, illustration of the electrochemical measuring device is omitted.

After inert gas is sufficiently blown into the cathode chamber 211 to replace air in the cathode chamber 211 with the inert gas, the applied voltage is controlled at 2.0 V and constant voltage electrolysis is performed in the same manner in the first experimental example 1 for 2 hours. Then, aqueous urea solution electrolysis activity is evaluated. The activity is evaluated by measuring the Faradaic efficiencies of hydrogen, nitrogen, and oxygen (i.e., FE (H₂), FE (N₂), FE (O₂)), the production rates of hydrogen, nitrogen, and oxygen production (i.e., r (H₂), r (N₂) and r(O₂)). The results are shown in FIGS. 17 to 19. Further, FIG. 16 shows the change in the current density over time in this example.

As is shown in FIG. 17, the Faradaic efficiency of hydrogen FE(H₂) at the cathode 21 is 100%, and the hydrogen production rate r(H₂) is also fast. This indicates that hydrogen is sufficiently produced at the cathode 21 at high efficiency in the hydrogen/ammonia producing device 1 in this example.

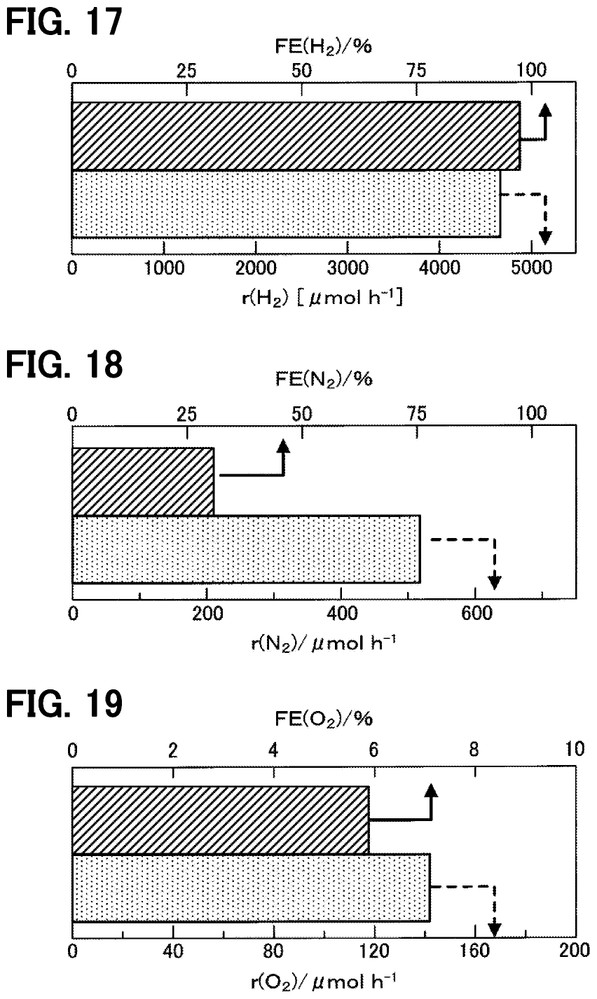

Further, as can be understood from FIG. 18, the current efficiency of nitrogen production is as low as about 30%, which indicates that nitrogen compounds other than nitrogen and ammonia are produced in the reaction solution.

Further, as can be understood from FIG. 19, the current efficiency of oxygen production is as low as about 6%, which indicates that urea is efficiently oxidized.

As described above, when an anion exchange membrane is used as the ion exchange membrane and the cathode chamber is in a dry environment, hydrogen and ammonia can be produced through the aqueous urea solution electrolysis.

The present disclosure is not limited to the embodiments described above, and various modifications may be adopted within the scope of the present disclosure without departing from the spirit of the disclosure.

What is claimed is:

1. A hydrogen ammonia producing device configured to produce hydrogen and/or ammonia, the hydrogen ammonia producing device comprising
an electrochemical cell including an electrode assembly and an electrolyte solution, wherein
the electrode assembly has a cathode, a separator and an anode that are sequentially stacked with each other,
the anode is in contact with urea,
the electrolyte solution is an alkaline aqueous solution,
at least one of the anode or the cathode is in contact with the electrolyte solution, and
the separator is an ion exchange membrane.

2. The hydrogen ammonia producing device according to claim 1, wherein
the ion exchange membrane is an anion exchange membrane.

3. The hydrogen ammonia producing device according to claim 1, wherein
the electrode assembly separates an inner space of the electrochemical cell into a space for the anode and a space for the cathode.

4. The hydrogen ammonia producing device according to claim 1, wherein
the electrode assembly is immersed in the electrolyte solution including the urea.

5. The hydrogen ammonia producing device according to claim 1, wherein
one of the anode or the cathode is in contact with the electrolyte solution and the other of the anode or the cathode is exposed to a dry environment.

6. The hydrogen ammonia producing device according to claim 1, wherein
the anode contains a base metal.

7. A method for producing hydrogen and/or ammonia comprising:
forming an electrode assembly by sequentially stacking a cathode, a separator formed of an ion exchange membrane, and an anode;
bringing the anode of the electrode assembly into contact with urea and bringing at least one of the anode or the cathode into contact with an electrolyte solution that is an alkaline aqueous solution; and
applying a voltage between the cathode and the anode to generate hydrogen and/or ammonia.

8. The method according to claim 7, wherein
the ion exchange membrane is an anion exchange membrane.

9. The method according to claim 7, wherein
bringing the anode of the electrode assembly into contact with the urea and bringing at least one of the anode or the cathode into contact with the electrolyte solution includes immersing the electrode assembly into the electrolyte solution including the urea.

10. The method according to claim 7, wherein
bringing at least one of the anode or the cathode into contact with the electrolyte solution includes bringing one of the anode or the cathode into contact with the electrolyte solution and exposing the other of the anode or the cathode to a dry environment.

11. The method according to claim 7, wherein
the anode contains a base metal.
